(19) United States
(12) Patent Application Publication
(10) Pub. No.: US 2008/0118906 A1
(43) Pub. Date: May 22, 2008

(54) METHOD FOR PROVIDING AN ONLINE TUTORIAL

(76) Inventor: JAMES M. MCARDLE, Austin, TX (US)

Correspondence Address: IBM CORPORATION (SWP), C/O SUITER SWANTZ PC LLO, 14301 FNB PARKWAY, SUITE 220, OMAHA, NE, 68154-5299, US

(21) Appl. No.: 11/561,425

(22) Filed: Nov. 20, 2006

(51) Int. Cl. G09B 7/00

(52) U.S. Cl. 434/362

(57) ABSTRACT

The present invention is a method for providing an online tutorial. The method includes presenting material of a first level of complexity, the presented first-level material being associated with a course topic. The method further includes receiving a user input responsive to at least one question included in the presented first-level material. The method further includes determining the user's mastery level of the presented first-level material based upon the received input. The method further includes presenting material of a second level of complexity when the user's mastery level of the presented first-level material is determined as meeting a pre-set standard, the second level of complexity being greater than the first level of complexity, the presented second-level material being associated with the course topic. The method further includes presenting additional first-level material when the user's mastery level of the presented first-level material is determined as not meeting the pre-set standard.

### FIELD OF THE INVENTION

The present invention relates to the field of electronic communications and particularly to a method for providing an online tutorial.

### BACKGROUND OF THE INVENTION

Teaching is considered by a number of people to be an art. Currently, online courses or tutorials are available which provide educational materials for teaching students. However, devising a single, online course or lesson plan which adequately addresses the needs of students at various learning levels presents certain challenges. For example, if the course is too simple, students who are fast learners/more familiar with the material may not be adequately challenged and may become easily bored with the course. Alternatively, if the course is too complex, although it may meet the needs of the fast learners, it may also prove to be overwhelming to students who are slower learners/less familiar with the material.

Therefore, it may be desirable to have a method for providing an online tutorial which improves upon current solutions by better addressing the above-referenced challenges associated with providing such tutorials.

### SUMMARY OF THE INVENTION

Accordingly, an embodiment of the present invention is directed to a method for providing an online tutorial. The method includes presenting material of a first level of complexity, the presented first-level material being associated with a course topic. The method further includes receiving a user input responsive to at least one question included in the presented first-level material. The method further includes determining the user's mastery level of the presented first-level material based upon the received input. The method further includes presenting material of a second level of complexity, when the user's mastery level of the presented first-level material is determined as meeting a pre-set standard, the second level of complexity being greater than the first level of complexity, the presented second-level material being associated with the course topic. The method further includes presenting additional first-level material when the user's mastery level of the presented first-level material is determined as not meeting the pre-set standard.

In a further embodiment, the present invention is directed to a method for providing an online tutorial. The method includes presenting material of a first level of complexity, the presented first-level material being associated with a course topic. The method further includes receiving a user input responsive to at least one question included in the presented first-level material. The method further includes determining the user's mastery level of the presented first-level material based upon the received input. The method further includes presenting material of a second level of complexity, the second level of complexity being greater than the first level of complexity when the user's mastery level of the presented first-level material is determined as meeting a pre-set standard, the presented second-level material being associated with the course topic. The method further includes presenting additional first-level material when the user's mastery level of the presented first-level material is determined as not meeting the pre-set standard. The method further includes, while presenting the first-level material, further presenting at least one link to the second-level material for allowing the user to view the second-level material prior to completing the first-level material when the user's mastery level of the first-level material is determined as meeting the pre-set standard.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flow chart illustrating a method for providing an online tutorial in accordance with an exemplary embodiment of the present invention; and

FIG. 2 illustrates computer-readable XML (Extensible Markup Language) for providing an online tutorial in accordance with exemplary embodiments of the present invention.

### DETAILED DESCRIPTION OF THE INVENTION

Reference will now be made in detail to the presently preferred embodiments of the invention, examples of which are illustrated in the accompanying drawings.

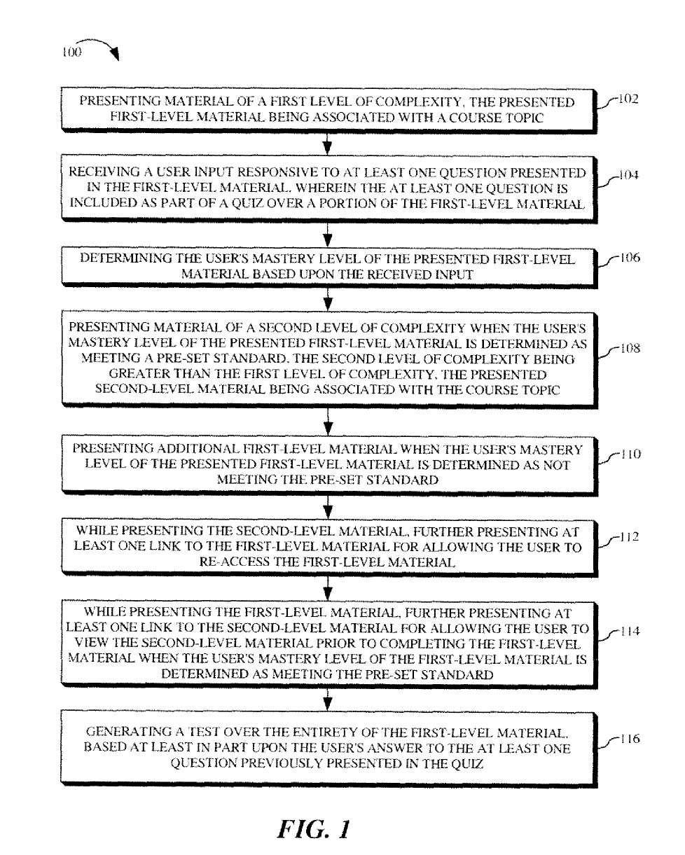

Referring generally to FIG. 1, a flow chart illustrating a method for providing an online tutorial in accordance with an exemplary embodiment of the present invention is shown. In a current embodiment, the method 100 includes presenting material of a first level of complexity, the presented first-level material being associated with a course topic 102. In exemplary embodiments, the online tutorial may present material covering a course topic, such that the material is divided into multiple levels of varying complexity. For instance, the first-level may include the most basic facts about a particular course topic. Once mastered, these first-level facts may establish a foundation for later learning at more complex levels.

In a present embodiment, the method 100 further includes receiving a user input responsive to at least one question included in the presented first-level material 104. In current embodiments, the at least one question may be included as part of a quiz over a portion of the first-level material. For example, each level may be further divided into various lessons, chapters and the like. Further, the user may be presented with one or more questions during navigation through the online tutorial, the questions being designed to test the user's mastery or grasp of the material. For instance, at the end of each chapter or lesson contained within the first-level material, the user may be presented with a quiz including a plurality of questions over the just-finished portion of the first-level material.

In an exemplary embodiment, the method 100 further includes determining the user's mastery level of the presented first-level material based upon the received input 106. For example, the user's mastery level may be determined by comparing the user inputs received in response to one or more presented questions to correct answers for the presented questions.

In a current embodiment, the method 100 further includes presenting material of a second level of complexity when the user's mastery level of the presented first-level material is determined as meeting a pre-set standard, the second level of complexity being greater than the first level of complexity, the presented second-level material being associated with the course topic 108. For example, a pre-set standard may be established, such as a certain number of questions, a certain percentage of questions or the like which must be answered correctly for the user to be considered as having mastery over the presented first-level material. In exemplary embodiments, when the user meets (i.e., equals or exceeds) the pre-set standard of mastery for the presented first-level material, second-level material may be presented to the user. For instance, the second-level material may cover the same course topic as the first-level material, yet may be more complex than the more basic, first-level material.

In a present embodiment, the method 100 further includes presenting additional first-level material when the user's mastery level of the presented first-level material is determined as not meeting (i.e., equaling or exceeding) the pre-set standard 110. For instance, if the user has not answered a sufficient number and/or percentage of questions over the first-level material correctly, the user may be determined as not meeting the pre-set standard. By not meeting the pre-set standard, the user may be determined as not having sufficiently mastered the first-level material in order to be ready for being presented with second-level material over the topic. Further, the user may be presented with additional questions, quizzes, review exercises, study materials, and the like for increasing the user's mastery level with respect to the first-level material, said additional first-level material not being presented to more advanced users/learners. For instance, the user, after completing the additional exercises and the like, may have answered enough questions correctly to be determined as having met the pre-set standard of mastery, thereby allowing the user to navigate to and/or be presented with second-level material.

In an exemplary embodiment, the method 100 further includes, while presenting the second-level material, further presenting at least one link to the first-level material for allowing the user to re-access the first-level material 112. For example, the user, while being presented with/studying higher level material (ex.—second-level, third-level, etc.), may be provided with one or more links to lower-level material (ex.—first-level), thereby allowing users who have advanced to higher levels to review previously covered material of a lower level(s).

In a current embodiment, the method 100 further includes, while presenting the first-level material, further presenting at least one link to the second-level material for allowing the user to view the second-level material prior to completing the first-level material when the user's mastery level of the first-level material is determined as meeting (i.e., equaling or exceeding) the pre-set standard 114. For instance, more advanced users (ex.—users who have an easier time meeting the pre-set standard of mastery for the presented first-level material) may wish to look ahead or browse the second-level material prior to completing the first-level material. Contrastingly, less advanced users may be required to: a) complete the entirety of the first-level material; and b) be determined as having mastery levels which meet the pre-set standard, prior to being able to access higher-level material. In this way, the present invention allows users to work through the material at different paces. Advanced users/learners working through material at a certain level may be allowed to peek ahead to deeper, more complex material at a higher level. Less advanced users/learners are forced to stay focused on the level at which they are presently working until they are deemed as having mastery levels which meet the pre-set standard. Further, less advanced users may be assisted with additional material in the form of extra questions, drills and the like, that may not be presented to more advanced users/learners.

In a present embodiment, the method 100 further includes generating a test over the entirety of the first-level material, based at least in part upon the user's answer to the at least one question previously presented in the quiz 116. In exemplary embodiments, the generated test may include at least one question from the previously presented quiz which was incorrectly answered by the user. In further embodiments, the generated test includes at least one multiple choice question, said multiple choice question including as a possible answer choice a previous incorrect answer received via user input to a question in the previously presented quiz. In this way, tests may be generated which are tailored to improving weaknesses of the particular user by testing and/or re-testing facets of the material with which that particular user has struggled with previously.

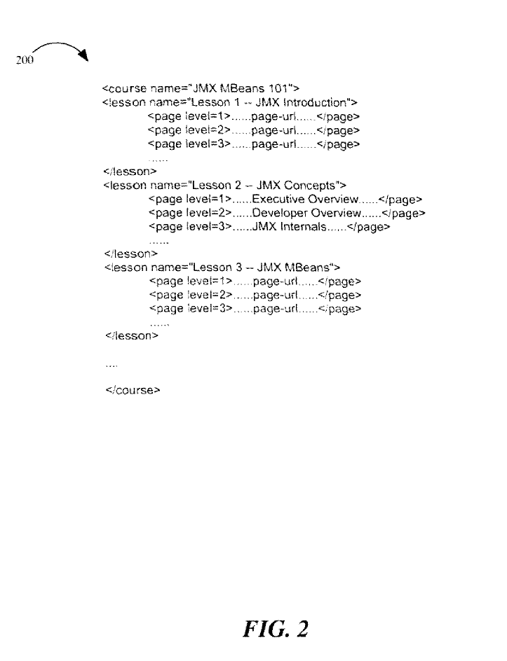

FIG. 2 illustrates computer-readable XML (Extensible Markup Language) 200 for providing an online tutorial in accordance with exemplary embodiments of the present invention. In a current embodiment, the computer-readable XML may be contained within a computer-readable course planning document. For example, the online tutorial may include multiple topics, wherein material of multiple levels of complexity may be presented for each topic. Further, the computer-readable XML may dictate which topics of the online tutorial are to be presented to the user and, under what circumstances, such as dictating that links to second-level material be presented to the user when the user is determined as having met the pre-set standard of mastery over the first-level material. It is contemplated in further embodiments, that the computer-readable course planning document may be authored in various languages known in the art aside from XML.

It is contemplated that the invention may take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

It is further contemplated that the medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, microphone, speakers, displays, pointing devices, and the like) may be coupled to the system either directly or through intervening I/O controllers.

Network adapters may also be coupled to the system to enable the data processing system to become coupled to other data processing systems or storage devices through intervening private or public networks. Modems, cable modem and Ethernet cards are just a few of the currently available types of network adapters.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages are to be understood by the foregoing description, and it is apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for providing an online tutorial, comprising:
presenting material of a first level of complexity, the presented first-level material being associated with a course topic;
receiving a user input responsive to at least one question included in the presented first-level material;
determining the user's mastery level of the presented first-level material based upon the received input;
presenting material of a second level of complexity when the user's mastery level of the presented first-level material is determined as meeting a pre-set standard, the second level of complexity being greater than the first level of complexity, the presented second-level material being associated with the course topic; and
presenting additional first-level material when the user's mastery level of the presented first-level material is determined as not meeting the pre-set standard.

2. A method as claimed in claim 1, further comprising:
while presenting the second-level material, further presenting at least one link to the first-level material for allowing the user to re-access the first-level material.

3. A method as claimed in claim 2, further comprising:
while presenting the first-level material, further presenting at least one link to the second-level material for allowing the user to view the second-level material prior to completing the first-level material when the user's mastery level of the first-level material is determined as meeting the pre-set standard.

4. A method as claimed in claim 3, wherein the at least one question is included as part of a quiz over a portion of the first-level material.

5. A method as claimed in claim 4, further comprising:
generating a test over the entirety of the first-level material, based at least in part upon the user's answer to the at least one question previously presented in the quiz.

6. A method as claimed in claim 5, wherein the generated test includes at least one question from the previously presented quiz which was incorrectly answered by the user.

7. A method as claimed in claim 6, wherein the generated test includes at least one multiple choice question, said multiple choice question including as a possible answer choice a previous incorrect answer received via user input to a question in the previously presented quiz.

8. A computer program product, comprising:
a computer useable medium including computer usable program code for performing a method for providing an online tutorial including:
computer usable program code for presenting material of a first level of complexity, the presented first-level material being associated with a course topic;
computer usable program code for receiving a user input responsive to at least one question included in the presented first-level material;
computer usable program code for determining the user's mastery level of the presented first-level material based upon the received input;
computer usable program code for presenting material of a second level of complexity when the user's mastery level of the presented first-level material is determined as meeting a pre-set standard, the second level of complexity being greater than the first level of complexity, the presented second-level material being associated with the course topic; and
computer usable program code for presenting additional first-level material when the user's mastery level of the presented first-level material is determined as not meeting the pre-set standard.

9. A computer program product as claimed in claim 8, further comprising:
a computer useable medium including computer usable program code for presenting at least one link to the first-level material while presenting the second-level material, thereby allowing the user to re-access the first-level material.

10. A computer program product as claimed in claim 9, further comprising:
a computer useable medium including computer usable program code for presenting at least one link to the second-level material while presenting the first-level material, thereby allowing the user to view the second-level material prior to completing the first-level material when the user's mastery level of the first-level material is determined as meeting the pre-set standard.

11. A computer program product as claimed in claim 10, wherein the at least one question is included as part of a quiz over a portion of the first-level material.

12. A computer program product as claimed in claim 11, further comprising:
a computer useable medium including computer usable program code for generating a test over the entirety of the first-level material, based at least in part upon the user's answer to the at least one question previously presented in the quiz.

13. A computer program product as claimed in claim 12, wherein the generated test includes at least one question from the previously presented quiz which was incorrectly answered by the user.

14. A computer program product as claimed in claim 13, wherein the generated test includes at least one multiple choice question, said multiple choice question including as a possible answer choice a previous incorrect answer received via user input to a question in the previously presented quiz.

15. A method for providing an online tutorial, comprising:
presenting material of a first level of complexity, the presented first-level material being associated with a course topic;
receiving a user input responsive to at least one question included in the presented first-level material;
determining the user's mastery level of the presented first-level material based upon the received input;
presenting material of a second level of complexity when the user's mastery level of the presented first-level material is determined as meeting a pre-set standard, the second level of complexity being greater than the first level of complexity, the presented second-level material being associated with the course topic;
presenting additional first-level material when the user's mastery level of the presented first-level material is determined as not meeting the pre-set standard; and
while presenting the first-level material, further presenting at least one link to the second-level material for allowing the user to view the second-level material prior to completing the first-level material when the user's mastery level of the first-level material is determined as meeting the pre-set standard.

16. A method as claimed in claim 15, further comprising:
while presenting the second-level material, further presenting at least one link to the first-level material for allowing the user to re-access the first-level material.

17. A method as claimed in claim 16, wherein the at least one question is included as part of a quiz over a portion of the first-level material.

18. A method as claimed in claim 17, further comprising:
generating a test over the entirety of the first-level material, based at least in part upon the user's answer to the at least one question previously presented in the quiz.

19. A method as claimed in claim 18, wherein the generated test includes at least one question from the previously presented quiz which was incorrectly answered by the user.

20. A method as claimed in claim 19, wherein the generated test includes at least one multiple choice question, said multiple choice question including as a possible answer choice a previous incorrect answer received via user input to a question in the previously presented quiz.
